(19) United States
(12) Patent Application Publication
(10) Pub. No.: US 2021/0042852 A1
(43) Pub. Date: Feb. 11, 2021

(54) RECOGNITION ON SOCIAL NETWORK PLATFORMS

(71) Applicant: International Business Machines Corporation, Armonk, NY (US)

(72) Inventors: Jenny S. Li, Cary, NC (US); Yu Deng, Yorktown Heights, NY (US); Al Chakra, Apex, NC (US)

(21) Appl. No.: 16/533,869

(22) Filed: Aug. 7, 2019

(51) Int. Cl. G06Q 50/00; G06Q 10/08; G06K 9/00; G06K 9/62

(52) U.S. Cl. CPC G06Q 50/01; G06K 9/6215; G06K 9/00362; G06Q 10/087

(57) ABSTRACT

A method for analyzing images of a user in a social network includes analyzing one or more images of a user to identify outfit characteristics, creating a digital inventory of the images of the user, calculating a repetition score for a user's outfit in one or more images of the user, wherein the repetition score is calculated relative to one or more stored images of the user, identifying recommended actions, corresponding to modifications to the outfit characteristics of the user in the images of the user, wherein the identified recommended actions result in a lower repetition score, notifying a user of one or more images of the user and the identified recommended actions, wherein the one or more images of the user have a repetition score greater than a threshold value, executing an appropriate action in a social media profile on a social network platform in a user's social network.

### BACKGROUND

The present invention relates generally to the field of image recognition, and more specifically to the detection of repeated outfits in posts in a user's social network.

The explosion of social media has created a culture in which fashion and staying up to date on new trends are important for maintaining social status. Many users aim to avoid wearing the same or a similar outfit more than once due to the repetition's negative effect it may have on the user's status on social media. Maintaining social status can be important for people like celebrities and Internet personalities who depend on their notoriety for their livelihoods.

### SUMMARY

As disclosed herein, a method for analyzing one or more images of a user in a social network includes analyzing one or more images of a user to identify outfit characteristics, creating a digital inventory of the one or more images of the user, calculating a repetition score for a user's outfit in one or more images of the user, wherein the repetition score is calculated relative to one or more stored images of the user, identifying recommended actions, corresponding to modifications to the outfit characteristics of the user in the one or more images of the user, wherein the identified recommended actions result in a lower repetition score, notifying a user of one or more images of the user and the identified recommended actions, wherein the one or more images of the user have a repetition score greater than a threshold value, executing an appropriate action in a social media profile on a social network platform in a user's social network, based, at least in part, on the repetition score calculated for a user's outfit in the one or more images of the user.

As disclosed herein, a computer system for analyzing one or more images of a user in a social network includes one or more computer processors, one or more computer-readable storage media, and program instructions stored on the computer-readable storage media for execution by at least one of the one or more processors, the program instructions comprising instructions to analyze one or more images of a user to identify outfit characteristics, create a digital inventory of the one or more images of the user, calculate a repetition score for a user's outfit in the one or more images of the user, wherein the repetition score is calculated relative to one or more stored images of the user, identify recommended actions corresponding to modifications to the outfit characteristics in the one or more images of the user, wherein the identified recommended actions result in a lower repetition score, notify a user of one or more images of the user and the identified recommended actions, wherein the one or more images of the user have a repetition score greater than a predetermined threshold value, and execute an appropriate action in a social media profile on a social network platform in a user's social network, based, at least in part, on the repetition score calculated for a user's outfit in the one or more images of the user.

As disclosed herein, a computer program product for analyzing one or more images of a user in a social network includes one or more computer readable storage media and program instructions stored on the one or more computer readable storage media, the program instructions comprising instructions to analyze one or more images of a user to identify outfit characteristics, create a digital inventory of the one or more images of the user, calculate a repetition score for a user's outfit in the one or more images of the user, wherein the repetition score is calculated relative to one or more stored images of the user, identify recommended actions corresponding to modifications to the outfit characteristics in the one or more images of the user, wherein the identified recommended actions result in a lower repetition score, notify a user of one or more images of the user and the identified recommended actions, wherein the one or more images of the user have a repetition score greater than a predetermined threshold value, and execute an appropriate action in a social media profile on a social network platform in a user's social network, based, at least in part, on the repetition score calculated for a user's outfit in the one or more images of the user.

### BRIEF DESCRIPTION OF THE DRAWINGS

FIG. 1 is a block diagram depicting an image analysis system in accordance with at least one embodiment of the present invention.

FIG. 2 is a flowchart depicting an outfit recognition method in accordance with at least one embodiment of the present invention.

FIG. 3 is a flowchart depicting an image analysis method in accordance with at least one embodiment of the present invention.

FIG. 4 is a block diagram of components of a computing system executing the image analysis system in accordance with an embodiment of the present invention.

### DETAILED DESCRIPTION

Image recognition refers to technologies that identify places, logos, people, objects, and other variables in an image. Image recognition software is used a variety of ways, from security to gaming. In recent years, image recognition technology has been implemented in the fashion industry and has led to an increase in available wardrobe organizing applications. Users may search for clothes or upload images of their clothes and catalog them digitally, creating a digital wardrobe that they can access from a computer or mobile device anywhere in the world. Embodiments of the present invention recognize that although current wardrobe organizing applications may help users organize their wardrobe, they fail to assist in reducing outfit repetition.

Embodiments of the present invention assist in reducing outfit repetition by recognizing outfits worn by a user in images in a social network and alerting the user of subsequent outfits that are similar to those worn previously. Current social media platforms do not possess the ability to recognize a user's outfit and compare an outfit to others that a user has worn in previously uploaded images. The present invention provides a method for comparing an outfit worn by a user with other outfits worn by the user and alerting the user of repeated outfits. Furthermore, the present invention provides methods for altering the user's outfit in an image so that the user can avoid repeating outfits in images on social media. The present invention improves the current state of detecting outfit repetition within social networks by storing images and data corresponding to the outfit worn by the user in a digital inventory to be used for detecting repeated outfits in subsequent images of the user.

The present invention will now be described in detail with reference to the Figures. Implementation of embodiments of the invention may take a variety of forms, and exemplary implementation details are discussed subsequently with reference to the Figures.

As used herein, the phrase “user's social network” describes a user's network of associated contacts across one or more social network platforms. This includes the user's page and any pages associated with the user's friends, followers, interests, etc. It should be appreciated that this is a non-exhaustive list of page associations and does not imply any limitations to the present invention.

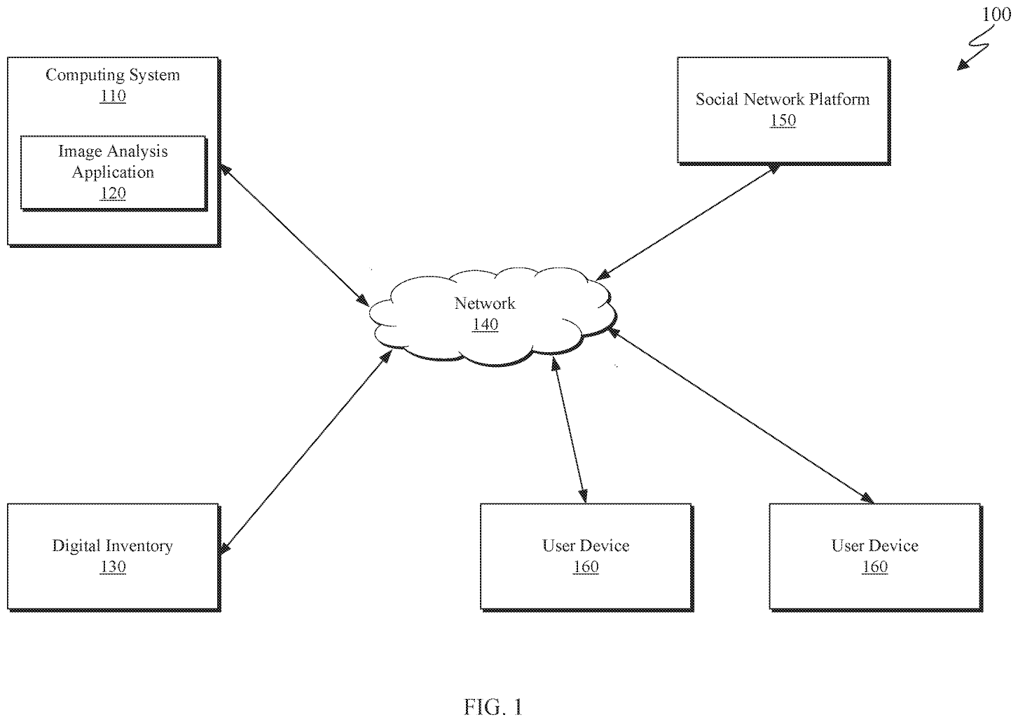

FIG. 1 is a block diagram depicting an image analysis system 100 in accordance with at least one embodiment of the present invention. As depicted, image analysis system 100 includes computing system 110, image analysis application 120, digital inventory 130, network 140, social network platform 150, and user devices 160. Image analysis system 100 may be configured to analyze a user's outfits and provide insights regarding said outfits.

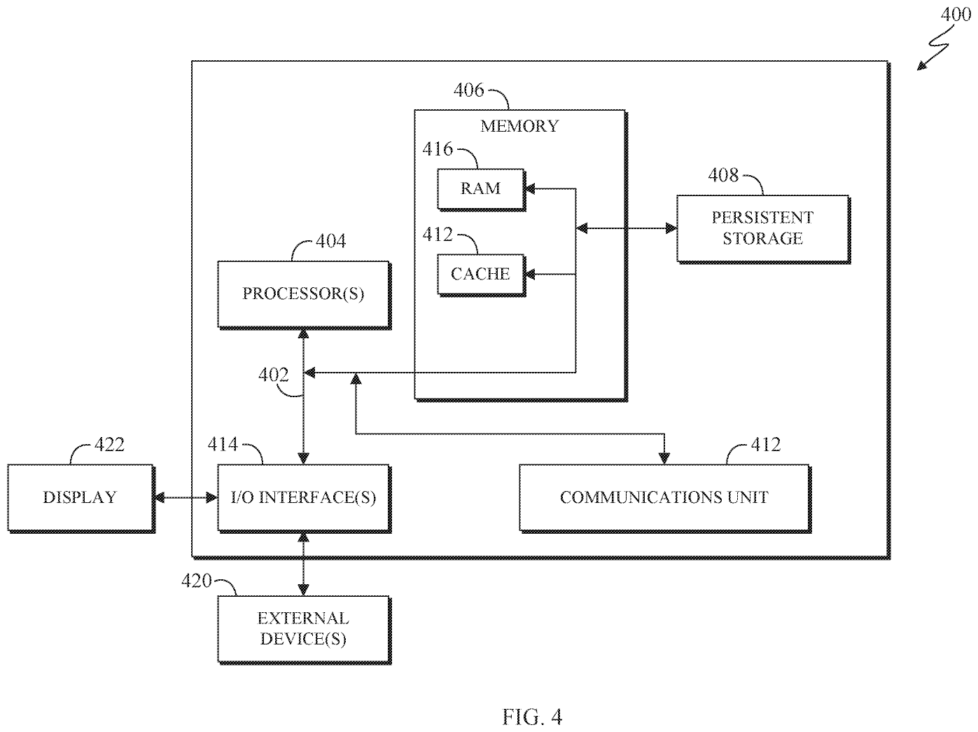

Computing system 110 can be a desktop computer, a laptop computer, a specialized computer server, or any other computer system known in the art. In some embodiments, computing system 110 represents computer systems utilizing clustered computers to act as a single pool of seamless resources. In general, computing system 110 is representative of any electronic device, or combination of electronic devices, capable of receiving and transmitting data, as described in greater detail with regard to FIG. 4. Computing system 110 may include internal and external hardware components, as depicted and described in further detail with respect to FIG. 4.

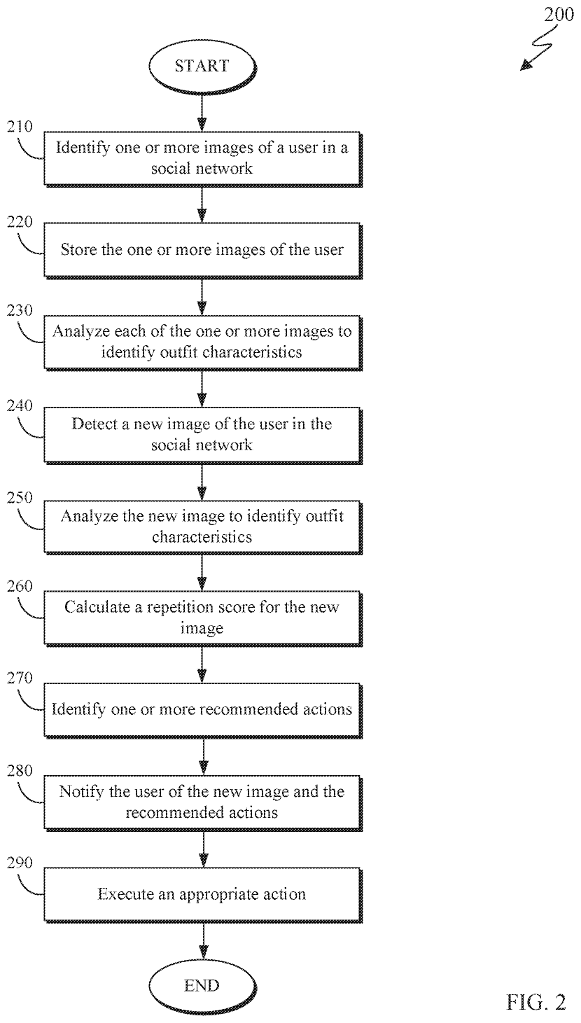

As depicted, computing system 110 comprises image analysis application 120. Image analysis application 120 is configurable to execute a social network image analysis method in accordance with at least one embodiment of the present invention. One embodiment of an appropriate image analysis method 200 is described with respect to FIG. 2. In general, image analysis application 120 is representative of any application capable of accessing a user's social network, analyzing images from the user's social network, cataloging images and corresponding image data in digital inventory 130, calculating a repetition score of an image in a user's social network, sending data to one or more user devices 160, and executing an appropriate action on a social network platform 150. In some embodiments, image analysis application 120 is outfitted with facial recognition software. In another embodiment, image analysis application 120 leverages facial recognition services offered by a social network platform. In some embodiments, image analysis application 120 is integrated with social network platform 150 such that the user may utilize the application through the social network platform's interface.

In various embodiments, digital inventory 130 is a data library implemented to store images of a user from the user's social network and corresponding data. Corresponding data may include, but is not limited to: title of the image, the date that the image was uploaded to the social network platform, the date the image was captured/created (if available), the name of the social network platform on which the image was found, and outfit characteristics corresponding to the user's outfit in the image. In some embodiments, digital inventory 130 contains images and data from all social network platforms on which the user has a user profile. In another embodiment, a separate digital inventory exists for each social network platform on which the user has a user profile, and only images and data from that particular social network platform are contained in a corresponding digital inventory. In at least one embodiment, digital inventory 130 is created in social network platform 150, where the images and data in the data library correspond to images found on social network platform 150. In other words, in such embodiments, each social network platform on which the user has a user profile has a digital inventory reflecting the images and corresponding data from that particular social network platform. While digital inventory 130 is depicted as existing externally from computing system 110, it should be appreciated that in another embodiment, digital inventory 130 may exist internally on computing system 110.

Network 140 can be, for example, a local area network (LAN), a wide area network (WAN) such as the Internet, or a combination of the two, and include wired, wireless, or fiber optics connections. In general, network 140 can be any combination of connections and protocols that will support communications between computing system 110, image analysis application 120, digital inventory 130, social network platform 150, and user devices 160 in accordance with an embodiment of the present invention.

Social network platform 150 is representative of any online platform used to build a social network with other users. In some embodiments, social network platform 150 features digital image sharing between users. In at least one embodiment, social network platform 150 enables a user to construct a user profile comprised of user characteristics, user preferences, images of the user, user interests, etc. In some embodiments, user preferences set on social networking platform 150 enable image analysis application 120 to perform certain functions based on those preferences. For example, in some embodiments, user preferences set on social network platform 150 can instruct image analysis application 120 to prevent the tagging of the user in an image that has a repetition score greater than a predetermined threshold value. In another embodiment, user preferences can instruct image analysis application 120 to change one or more outfit characteristics of a user's outfit in an image such that the repetition score decreases below a predetermined threshold value. In another embodiment, user preferences can instruct image analysis application 120 to notify the user and provide recommended actions.

User devices 160 may be a desktop computer, laptop computer, tablet computer, mobile phone, or any other device. In general, user devices 160 are representative of any electronic device or devices capable of accessing a social network platform, receiving data from a network, transmitting data on a network, and displaying information to a user. In various embodiments, user devices 160 are capable of receiving a notification from image analysis application 120 containing information about an image, such as the repetition score, the outfit characteristics, and recommended actions. In some embodiments, user devices 160 are additionally capable of receiving user input and providing that input to image analysis application 120 regarding appropriate actions with respect to an outfit in a user image. In some embodiments, user devices 160 are configured to access social network platform 150.

FIG. 2 is a flowchart depicting outfit recognition method 200 in accordance with at least one embodiment of the present invention. As depicted, outfit recognition method 200 includes identifying (210) one or more images of a user in a social network, storing (220) the one or more images of the user, analyzing (230) each of the one or more images to identify outfit characteristics, detecting (240) a new image of the user in the social network, analyzing (250) the new image to identify outfit characteristics, calculating (260) a repetition score for the new image, identifying (270) one or more recommended actions, notifying (280) the user of the new image and one or more recommended actions, and executing (290) an appropriate action.

In various embodiments, identifying (210) one or more images of a user in a social network includes image analysis application 120 analyzing images in the user's social network. Here, image analysis application 120 analyzes images in the user's social network to determine which images the user appears in. In some embodiments, image analysis application 120 analyzes the images with facial recognition software to identify images in which the user appears. Facial recognition software compares facial features from a given image with faces in other images within a database. For example, an algorithm analyzes the relative position, size, and/or shape of the eyes, nose, cheekbones, and jaw. These features are then used to search for other images with matching features. In embodiments in which facial recognition software is used, image analysis application 120 analyzes the images and identifies the images in which the user's face appears. In some embodiments, identifying (210) one or more images of a user in a social network additionally includes training a facial recognition model to recognize the user's face in images. In some embodiments, the model is employed to access the user's social network and analyze images of the user to develop familiarity with the user's facial features and create a facial profile used to identify the user in subsequent, new images. In another embodiment, the model is provided with images of the user to establish identifying features of the user's face, such as relative position, size, and shape of the eyes, nose, cheekbones, and jaw, in order to create a facial profile used to identify the user in new images. In some embodiments, image analysis application 120 analyzes existing images in the user's social network that includes multiple social network platforms. In another embodiment, image analysis application 120 analyzes existing images in the user's social network that includes a single social network platform. In some embodiments, image analysis application 120 is outfitted with a facial recognition software. In another embodiment, image analysis application 120 leverages existing facial recognition software being implemented by a given social network platform. Examples of social network platforms with facial recognition software include, but are not limited to, Facebook.

In various embodiments, storing (220) the one or more images of the user includes image analysis application 120 creating a digital inventory that contains the images of the user from the user's social network. In some embodiments, storing (220) the one or more images of the user additionally includes image analysis application 120 creating a data table in which data corresponding to the images contained in the data inventory is input. Corresponding data contained in the data table may include, but is not limited to, title of the image, the date that the image was uploaded to the social network platform, the date the image was captured/created (if available), and the name of the social network platform on which the image was found. In some embodiments, the image title may reflect where the user is in the image or what the user is doing in the image. In other words, the image title reflects information regarding an event where the image was taken. In at least one embodiment, the digital inventory can be connected with a user profile, wherein the user profile is a digital representation of the user on one or more social network platforms. The user profile may contain information such as, but not limited to, characteristics about the user and preferences set by the user.

In various embodiments, analyzing (230) each of the one or more images to identify outfit characteristics include image analysis application 120 processing an image to determine information about the clothes that the user is wearing in the image. Outfit characteristics may include, but are not limited to, type of clothing (i.e. shirt, pants, dress, etc.), color of the clothing, style of the clothing (i.e. button down shirt, T-shirt, jeans, etc.), footwear worn, and accessories worn (i.e. jewelry, hats, etc.). Image analysis application 120 may then input data reflecting outfit characteristics into the digital inventory with the corresponding image of the user. For example, if the user is wearing a black shirt, jeans, and black sandals in an image, then image analysis application 120 may input “black shirt, jeans, black sandals” as outfit characteristics in the data table corresponding to the image in the data library.

In various embodiments, detecting (240) a new image of the user in the social network includes image analysis application 120 monitoring the social network. In some embodiments, image analysis application 120 monitors the activities of the user's associated contacts (friends, followers, etc.) in the user's social network. This may include analyzing images posted by the user's associated contacts to determine whether the user appears in any images. In another embodiment, image analysis application 120 monitors activities of the user's friends and any public accounts in the user's social network. A public account is an account that is viewable to everyone that has access to the social network platform. In another embodiment, image analysis application 120 monitors activities of all users in the social network platform. In some embodiments, image analysis application 120 monitors activities across multiple social network platforms, including but not limited to, Facebook, Twitter, Instagram, and Tumblr. In another embodiment, image analysis application 120 monitors activities on a single social network platform. In some embodiments, detecting (240) a new image of the user in the social network additionally includes image analysis application 120 identifying the user in an image. Image analysis application 120 may use facial recognition software to identify the user in a new image. In some embodiments, the new image is added to the digital inventory in accordance with Step 220.

In various embodiments, analyzing (250) the new image to identify outfit characteristics includes image analysis application 120 processing the new image to determine characteristics of the clothes that the user is wearing in the image. Outfit characteristics may include, but are not limited to: type of clothing worn (i.e. shirt, pants, dress, etc.), color of the clothing, style of the clothing (i.e. button down shirt, T-shirt, jeans, sandals etc.), footwear worn, and accessories worn (i.e. jewelry, hats, etc.). In some embodiments, image analysis application 120 adds the new image to the digital inventory with corresponding data. In such embodiments, image analysis application 120 may additionally annotate the new image with labels corresponding to the identified outfit characteristics. For example, if the user is wearing a black shirt, jeans, and black sandals in the new image, then image analysis application 120 labels the black shirt, the jeans, and the black sandals in the image. Labeling in such a manner can aid with error detection and user comprehension.

In various embodiments, calculating (260) a repetition score for the new image includes image analysis application 120 comparing the outfit characteristics in the new image with outfit characteristics of images stored in the digital inventory to determine a similarity score. In some embodiments, the similarity score reflects the level of similarity of the user's outfit in the new image and the user's outfit in a stored image, where the user's outfit is comprised of the outfit characteristics. In some embodiments, the similarity score and level of similarity of the user's outfit in the new image and the user's outfit in the stored image is directly related; in other words, a low similarity score indicates that the images are not similar. In another embodiment, the similarity score and level of similarity of the user's outfit in the new image and the user's outfit in the stored image is inversely related; in other words, a high similarity score indicates the images are not similar. In another embodiment, their relationship can reflect another statistical relationship. In some embodiments, the outfit characteristics are weighted equally. For example, the color of the user's shirt in the images and the style of the user's shirt in the images contribute to the similarity score equally. In another embodiment, outfit characteristics are not be weighted equally. For example, color of clothing is more heavily weighted than style of clothing because the former may be more visually apparent than the latter. In some embodiments, the similarity score reflects the similarity of the entire outfit. For example, if the user outfit characteristics in the new image are “black shirt, jeans, and black shoes,” and there exists an image in the digital inventory with outfit characteristics “black shirt, jeans, and black shoes,” then the new image would be determined to have a high level of similarity with the image stored in the digital inventory. In another embodiment, image analysis application 120 determines the similarity score for each corresponding outfit element in the new image and the stored image, where an outfit element is comprised of outfit characteristics. In other words, image analysis application 120 determines a level of similarity of a user's shirt, pants, and shoes in the new image and the stored image independently. For example, if the user outfit characteristics in the new image are “black shirt, jean, black shoes,” and the characteristics in the stored image are “black shoes, jeans, blue shoes,” image analysis application 120 would determine the shirts have one similarity score, the pants have another similarity score, and the shoes have yet another similarity score. In some embodiments, image analysis application 120 aggregates those values into a single similarity score. In another embodiment, image analysis application 120 factors the similarity score of individual outfit elements into the repetition score independently. It should be appreciated that image analysis application 120 can factor in any number of outfit characteristics into its determination of a level of similarity and is not limited by the reference to some but not others in this method. In some embodiments, calculating (260) a repetition score for the new image additionally includes image analysis application 120 comparing the date that the new image was uploaded with the dates that images that share similar outfit characteristics in the digital inventory were uploaded. In some embodiments, image analysis application 120 assigns a value to represent the temporal proximity of the date of the new image and stored image based on preferences in a user profile. For example, image analysis application 120 may assign a value “y” if the new image is uploaded less than 30 days after the stored image, a value of “z” if the new image is uploaded between 30 and 60 days after the stored image, and so on. This value may then be combined arithmetically with the similarity score to calculate a repetition score. In an embodiment where the date that the image was captured is available, image analysis application 120 uses that date for comparison instead of the upload date. In at least one embodiment, the repetition score is a function of the similarity of the new and previous outfit characteristics and the dates that the images were uploaded to the social network platform/captured. In an embodiment where the new outfit is determined to be similar to a previous outfit, the repetition score assigned may be greater if the date that the new image was uploaded is close to the date that the image stored in the digital inventory was uploaded. In other words, image analysis application 120 determined that the user wore a similar outfit in a new image not long after the user wore that outfit in an image stored in the digital inventory.

Provided here is an example of an equation used to calculate (260) the repetition score Rep of a new image in the user's social network.

$$Rep = α \frac{1}{n} {\sum }_{1}^{n} {β}_{n} {x}_{n}$$

As depicted, α represents the value assigned based on the temporal proximity of the upload date of the new image and the stored image, βₙ represents the weight of a given outfit characteristic, xₙ represents an individual outfit characteristic, and n represents the total number of outfit characteristics. In this equation, xₙ equals 1 when an outfit characteristic is present in both the new image and a stored image, and equals 0 when an outfit characteristic is present in one image but not the other. As depicted, this equation calculates the repetition score of a new image with respect to a single stored image. In an embodiment where the new image is compared with more than one stored image, the independent repetition scores Rep are aggregated. In another embodiment, another equation can be used to calculate the repetition score of a new image with respect to one or more stored images.

In various embodiments, identifying (270) one or more recommended actions includes image analysis application 120 processing the repetition score. Here, image analysis application 120 generates recommended actions based on the repetition score. In some embodiments, image analysis application 120 recommends that the new image be modified to decrease the level of similarity between the new outfit and a previous outfit. In some embodiments, image analysis application 120 generates recommended actions that decrease the repetition score below a predetermined threshold value. In some embodiments, image analysis application 120 recommends changing one or more outfit characteristics depending on the repetition score calculated. For example, image analysis application 120 may generate recommended actions that include more comprehensive and holistic modifications to the new image for greater repetition scores. Image analysis application 120 may use existing photo editing techniques to, for example, change the color of one or more outfit elements in the new image, change the style of one or more outfit elements, or add additional elements to the new outfit (i.e. accessories, hats, etc.). In some embodiments, image analysis application 120 recommends that the user replace an outfit element in the new image with an outfit element stored in the user's digital inventory. For example, the repetition score of the new image may be decreased if image analysis application 120 replaces the user's shirt in the new image with one in a stored image. In this scenario, image analysis application 120 may use existing photo editing techniques to superimpose the shirt from the stored image over the user's shirt in the new image. In another embodiment, Image analysis application 120 recommends that the image not “tag” the user in it. When a user is “tagged” in an image on a social media platform, the user is identified in the image and the image is available on the user's profile. By choosing not to “tag” one's self in an image, a user is preventing the image from becoming available on his/her user profile. More generally, image analysis application 120 may recommend that the user take, or not take, any number of actions relative to the photo that are available via a social media platform. In another embodiment, image analysis application 120 recommends that no action be taken. These recommended actions illustrate examples of possible actions and are not exhaustive of recommended actions available to image analysis application 120.

In various embodiments, notifying (280) the user of the new image and recommended actions includes image analysis application 120 generating a message and sending the message to the user with information about the new image, the previous image, and the recommended actions. Information provided to the user may include, but is not limited to, the repetition score, the identity of the uploading account, the similarities in the outfits, the date that each image was uploaded, and the existing image in which the previous outfit appears. In some embodiments, the user is notified if the repetition score determined in step 260 is above a predetermined threshold. In some embodiments, the user defines the threshold value for notifying the user. In another embodiment, image analysis application 120 defines the threshold value for notifying the user. In some embodiments, the user may set preferences on a user profile that create automated responses to a repetition score that exceeds the predetermined threshold. In these embodiments, image analysis application 120 does not notify the user of the new image and recommended actions, but instead proceeds to executing (290) an appropriate action according to the user's preferences.

In various embodiments, executing (290) an appropriate action includes image analysis application 120 performing the action chosen by the user. In some embodiments, the action is one chosen by the user from the recommended actions provided in step 280. In other embodiments, the user can set preferences that instruct image analysis application 120 to execute a given action automatically.

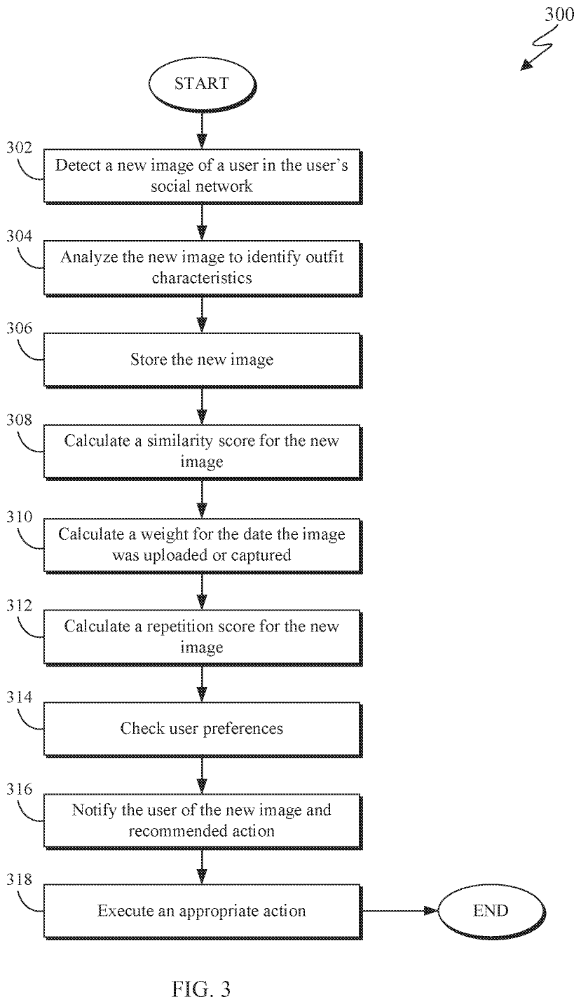

FIG. 3 is a flowchart depicting an image analysis method 300 in accordance with at least one embodiment of the present invention. As depicted, image analysis method 300 includes detecting (302) a new image of a user in a user's social network, analyzing (304) the new image to identify outfit characteristics, storing (306) the new image, calculating (308) a similarity score for the new image, calculating (310) a weight for the date the image was uploaded/captured, calculating (312) a repetition score for the new image, checking (314) user preferences, notifying (316) the user of the new image and recommended actions, and executing (318) an appropriate action. Image analysis method 300 may enable a user to filter/control social media posts that include pictures of said user.

In various embodiments, detecting (302) a new image of the user in the social network includes image analysis application 120 monitoring the user's social network. In some embodiments, image analysis application 120 monitors the activities of the user's associated contacts (friends, followers, etc.) in the social network. This may include analyzing images posted by the user's associated contacts to determine whether the user appears in any images. In another embodiment, image analysis application 120 monitors activities of the user's friends and any public accounts in the social network. A public account is an account that is viewable to everyone that has access to the social network platform. In another embodiment, image analysis application 120 monitors activities of all users in a social network platform. In some embodiments, image analysis application 120 monitors activities across multiple social network platforms, including but not limited to, Facebook, Twitter, Instagram, and Tumblr. In another embodiment, image analysis application 120 monitors activities on a single social network platform. In yet another embodiment, image analysis application 120 monitors activities on only social media platforms which a user indicated within his/her user profile. For example, the user may provide image analysis application 120 with access to three social media platforms such that the system can use all of the photos from these various platforms as a basis for outfit analysis. The user may, however, only want to filter posts to one of the three platforms, which he/she may indicate within a user profile. In some embodiments, detecting (302) a new image of the user in the social network additionally includes image analysis application 120 identifying the user in an image. Image analysis application 120 may use facial recognition software to identify the user in a new image. In another embodiment, image analysis application 120 identifies the user in an image based on image data, including but not limited to, tagging. In some embodiments, image analysis application 120 uses facial recognition software to verify tags that have been applied to an image by a user.

In various embodiments, analyzing (304) the new image to identify outfit characteristics includes image analysis application 120 processing the new image to determine characteristics of the clothes that the user is wearing in the image. Outfit characteristics may include, but are not limited to, the type of clothing worn (i.e. shirt, pants, dress, etc.), color of the clothing, style of the clothing (i.e. button down shirt, T-shirt, jeans, sandals etc.), footwear worn, and accessories worn (i.e. jewelry, hats, etc.). In some embodiments, image analysis application 120 adds the new image to the data inventory with corresponding data. In such embodiments, image analysis application 120 may additionally annotate the new image with labels corresponding to the identified outfit characteristics. For example, if the user is wearing a black shirt, jeans, and black sandals in the new image, then image analysis application 120 may label the black shirt, the jeans, and the black sandals in the image. Labeling in such a manner can aid with error detection and user comprehension.

In various embodiments, storing (306) the new image includes image analysis application 120 adding the new image to the digital inventory and inputting corresponding image data in the data table. Corresponding data may include, but is not limited to, title of the image, the date that the image was uploaded to the social network platform, the date the image was captured/created (if available), the name of the social network platform on which the image was found, and outfit characteristics. In some embodiments, storing (306) the new image includes image analysis application 120 creating a digital inventory that contains new images of the user. In some embodiments, this digital inventory would be different than the digital inventory created in step 220 of method 200. In other embodiments, the new images may be added to the digital inventory created in step 220 of method 200.

In various embodiments, calculating (308) a similarity score for the new image includes image analysis application 120 comparing the outfit characteristics of the new image with outfit characteristics of a stored image in the digital inventory. In some embodiments, the similarity score reflects the level of similarity between the user's outfit in the new image and the user's outfit in the stored image. In some embodiments, the similarity score reflects the level of similarity of the user's outfit in the new image and the user's outfit in the stored image, where the user's outfit is comprised of the outfit characteristics. In some embodiments, the similarity score and level of similarity of the user's outfit in the new image and the user's outfit in the stored image are directly related; in other words, a low similarity score and/or similarity score below a predetermined threshold indicates that the images are not similar. In another embodiment, the similarity score and level of similarity of the user's outfit in the new image and the user's outfit in the stored image are inversely related; in other words, a high similarity score and/or similarity score above a predetermined threshold indicates that the images are not similar. In another embodiment, their relationship can be reflected by another statistical relationship. In some embodiments, the outfit characteristics are weighted equally. For example, the color of the user's shirt in the images and the style of the user's shirt in the images contribute to the similarity score equally. In another embodiment, outfit characteristics are not weighted equally. For example, color of clothing may be more heavily weighted than style of clothing because the former may be more visually apparent than the latter. In some embodiments, the similarity score reflects the similarity of the entire outfit. For example, if the user outfit characteristics in the new image are “black shirt, jeans, and black shoes,” and there exists an image in the digital inventory with outfit characteristics “black shirt, jeans, and black shoes,” then the new image would be determined to have a relatively high level of similarity with the image in the digital inventory. In another embodiment, image analysis application 120 determines the similarity score for each corresponding outfit element in the new image and the stored image, where an outfit element is comprised of outfit characteristics. In other words, image analysis application 120 may determine a level of similarity of a user's shirt, pants, and shoes in the new image and the stored image independently. For example, if the user outfit characteristics in the new image are “black shirt, jean, black shoes,” and the characteristics in the stored image are “black shoes, jeans, blue shoes,” image analysis application 120 would determine the shirts have one similarity score, the pants have another similarity score, and the shoes have yet another similarity score. In some embodiments, image analysis application 120 aggregates those values into a single similarity score. In another embodiment, image analysis application 120 factors the similarity score of individual outfit elements into the repetition score independently. It should be appreciated that image analysis application 120 may factor in any number of outfit characteristics into its determination of a level of similarity and is not limited by the reference to some but not others in this method. In some embodiments, image analysis application 120 uses the following equation to calculate similarity score for a new image:

$$\frac{1}{n} {\sum }_{1}^{n} {β}_{n} {x}_{n}$$

where βᵢₙ represents the weight of a given outfit characteristic, xₙ represents an individual outfit characteristic, and n represents the total number of outfit characteristics. In an embodiment where each outfit characteristic is weighted equally, βₙ may be calculated using the following equation:

$${β}_{n} = \frac{1}{n}$$

where n equals the number of outfit characteristics. In embodiment where each outfit characteristic is not weighted equally, βₙ may be determined by user preferences. For example, a user may indicate to image analysis application 120 that the outfit characteristic “color” is more important than the outfit characteristic “style.” Image analysis application 120 may then assign a greater βₙ value to “color” than “style.” In another embodiment, user preferences may instruct image analysis application 120 not to factor a given outfit characteristic. In other words, image analysis application 120 may assign a weight βₙ of zero to the given outfit characteristic.

In various embodiments, calculating (310) a weight for the date the new image was uploaded/captured includes image analysis application 120 comparing the date that the new image was uploaded/captured with the upload/capture date of a stored image. In some embodiments, image analysis application 120 compares the date of the new image with the dates of stored images that have a similarity score greater than a predetermined threshold value. For example, image analysis application 120 may assign a value “y” if the new image is uploaded less than 30 days after the stored image, a value of “z” if the new image is uploaded between 30 and 60 days after the stored image, and so on. This value may then be combined arithmetically with the similarity score to calculate a repetition score. In another embodiment, image analysis application 120 uses the following equation to calculate a weight for the date the new image was uploaded/captured:

$$α = \frac{1}{{d}_{2} - {d}_{1}}$$

where α represents the weight of the upload/capture date, d₂ represents the date the new image was uploaded/captured, and d₁ represents the date that the stored image was uploaded/captured. In an embodiment using this equation, the dates d₂ and d₁ may be represented as integer values such the difference of the two equals the number of days between the two dates. In an embodiment where the date that the image was captured is available, image analysis application 120 may use that date for comparison instead of the upload date.

In various embodiments, calculating (312) a repetition score for the new image includes image analysis application 120 arithmetically combining the similarity score with the weight of the upload/capture date. In some embodiments, image analysis application 120 uses the following formula to calculate the repetition score Rep,

$$Rep = α \frac{1}{n} {\sum }_{1}^{n} {β}_{n} {x}_{n}$$

where α represents the weight of the upload/capture date, βₙ represents the weight of a given outfit characteristic, xₙ represents an individual outfit characteristic, and n represents the number of outfit characteristics. In this equation, xₙ equals 1 when an outfit characteristic is present in both the new image and a stored image and equals 0 when an outfit characteristic is present in one image but not the other. In other words, image analysis application 120 only factors common outfit characteristics in the calculation of the repetition score. In another embodiment, image analysis application 120 considers outfit characteristics not common to the new image and the stored image. As depicted, this equation calculates the repetition score of a new image with respect to a single stored image. In an embodiment where the new image is compared with more than one stored image, the independent repetition scores Rep is aggregated. In another embodiment, image analysis application 120 uses a different equation to calculate the repetition score of a new image and one or more stored images.

In various embodiments, checking (314) user preferences includes image analysis application 120 analyzing the user profile to determine the next appropriate action. In some embodiments, the user sets user preferences that instruct image analysis application 120 to notify the user of a new image and recommended actions if the repetition score of the new image exceeds a threshold score. In another embodiment, the user sets preferences that instruct image analysis application 120 to execute an appropriate action if the repetition score of the new image exceeds a predetermined threshold score without notifying the user. In some embodiments, the user preferences establish multiple predetermined threshold repetition scores with corresponding actions if one is exceeded. For example, the user preferences may instruct image analysis application 120 to modify the user's outfit in the image if the repetitions score of the new image exceeds a threshold, and to remove a tag of the user in the new image if the repetition score exceeds a second threshold. In another embodiment, the user preferences instruct image analysis application 120 to notify the user of all new images and recommend actions without reference to a predetermined threshold repetition score. In another embodiment, the user preferences instruct image analysis application 120 to execute some combination of notifying the user and executing an action without notifying the user.

In various embodiments, notifying (316) the user of the new image and recommended actions includes image analysis application 120 generating a message and sending the message to the user with information about the new image, one or more stored images, and the recommended actions. Information provided in the message may include, but is not limited to, the repetition score, the similarity score, the upload/capture date of the new image and the one or more stored images, and one or more stored images. In some embodiments, image analysis application 120 sends a message to the user via one or more messaging systems. For example, image analysis application 120 may send a message to the user's profile on one or more social network platforms, a user's mobile device, and a user's email. It should be appreciated that this is a non-exhaustive list of messaging services that image analysis application 120 may use to send the generated message to the user.

In various embodiments, executing (318) an appropriate action includes image analysis application 120 performing the action chosen by the user. In some embodiments, the action is one chosen by the user from the recommend actions provided in step 280. In another embodiment, the user sets preferences that instruct image analysis application 120 to execute a given action automatically.

FIG. 4 depicts a block diagram of components of computing system 110 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

As depicted, the computer 400 includes communications fabric 402, which provides communications between computer processor(s) 404, memory 406, persistent storage 408, communications unit 412, and input/output (I/O) interface(s) 414. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 416 and cache memory 418. In general, memory 406 can include any suitable volatile or non-volatile computer-readable storage media.

One or more programs may be stored in persistent storage 408 for access and/or execution by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 412, in these examples, provides for communications with other data processing systems or devices. In these examples, communications unit 412 includes one or more network interface cards. Communications unit 412 may provide communications through the use of either or both physical and wireless communications links.

I/O interface(s) 414 allows for input and output of data with other devices that may be connected to computer 400. For example, I/O interface 414 may provide a connection to external devices 420 such as a keyboard, keypad, a touch screen, and/or some other suitable input device. External devices 420 can also include portable computer-readable storage media such as, for example, thumb drives, portable optical or magnetic disks, and memory cards. Software and data used to practice embodiments of the present invention can be stored on such portable computer-readable storage media and can be loaded onto persistent storage 408 via I/O interface(s) 414. I/O interface(s) 414 also connect to a display 422.

Display 422 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method for analyzing one or more images of a user in a social network, the method comprising;
analyzing one or more images of a user to identify outfit characteristics;
creating a digital inventory of the one or more images of the user;
calculating a repetition score for a user's outfit in the one or more images of the user, wherein the repetition score is calculated relative to one or more stored images of the user;
identifying recommended actions corresponding to modifications to the outfit characteristics in the one or more images of the user, wherein the identified recommended actions result in a lower repetition score;
notifying a user of one or more images of the user and the identified recommended actions, wherein the one or more images of the user have a repetition score greater than a predetermined threshold value; and
executing an appropriate action in a social media profile on a social network platform in a user's social network, based, at least in part, on the repetition score calculated for a user's outfit in the one or more images of the user.

2. The computer implemented method of claim 1, further comprising monitoring a user's social network.

3. The computer implemented method of claim 2, further comprising storing the analyzed one or more images of the user and the corresponding identified outfit characteristics in the digital inventory.

4. The computer implemented method of claim 2, further comprising identifying one or more new images of the user in the user's social network.

5. The computer implemented method of claim 1, further comprising calculating a similarity score of two or more images of a user.

6. The computer implemented method of claim 5, wherein the identified recommended actions result in a lower similarity score.

7. The computer implemented method of claim 1, wherein calculating a repetition score comprises calculating a weight corresponding to timestamp information of two or more images of a user.

8. A computer program product for analyzing one or more images of a user in a social network, the computer program product comprising:
one or more computer readable storage media and program instructions stored on the one or more computer readable storage media, the program instructions comprising instructions to:
analyze one or more images of a user to identify outfit characteristics;
create a digital inventory of the one or more images of the user;
calculate a repetition score for a user's outfit in the one or more images of the user, wherein the repetition score is calculated relative to one or more stored images of the user;
identify recommended actions corresponding to modifications to the outfit characteristics in the one or more images of the user, wherein the identified recommended actions result in a lower repetition score;
notify a user of one or more images of the user and the identified recommended actions, wherein the one or more images of the user have a repetition score greater than a predetermined threshold value; and
execute an appropriate action in a social media profile on a social network platform in a user's social network, based, at least in part, on the repetition score calculated for a user's outfit in the one or more images of the user.

9. The computer program product of claim 8, further comprising instructions to monitor a user's social network.

10. The computer program product of claim 9, further comprising instructions to store the analyzed one or more images of the user and the corresponding identified outfit characteristics in the digital inventory.

11. The computer program product of claim 9, further comprising instructions to identify one or more new images of the user in the user's social network.

12. The computer program product of claim 8, further comprising instructions to calculate a similarity score of two or more images of a user.

13. The computer program product of claim 12, wherein the identified recommended actions result in a lower similarity score.

14. The computer program product of claim 8, wherein calculating a repetition score comprises calculating a weight corresponding to timestamp information of two or more images of a user.

15. A computer system for analyzing one or more images of a user in a social network, the computer program product comprising:
one or more computer processors;
one or more computer-readable storage media;
program instructions stored on the computer-readable storage media for execution by at least one of the one or more processors, the program instructions comprising instructions to:
analyze one or more images of a user to identify outfit characteristics;
create a digital inventory of the one or more images of the user;
calculate a repetition score for a user's outfit in the one or more images of the user, wherein the repetition score is calculated relative to one or more stored images of the user;
identify recommended actions corresponding to modifications to the outfit characteristics in the one or more images of the user, wherein the identified recommended actions result in a lower repetition score;
notify a user of one or more images of the user and the identified recommended actions, wherein the one or more images of the user have a repetition score greater than a predetermined threshold value; and
execute an appropriate action in a social media profile on a social network platform in a user's social network, based, at least in part, on the repetition score calculated for a user's outfit in the one or more images of the user.

16. The computer system of claim 15, further comprising instructions to monitor a user's social network.

17. The computer system of claim 16, further comprising instructions to store the analyzed one or more images of the user and the corresponding identified outfit characteristics in the digital inventory.

18. The computer system of claim 16, further comprising instructions to identify one or more new images of the user in the user's social network.

19. The computer system of claim 15, further comprising instructions to calculate a repetition score comprises calculating a similarity score of two or more images of a user.

20. The computer system of claim 19, wherein the identified recommended actions result in a lower similarity score.
